(19) United States
(12) Patent Application Publication
(10) Pub. No.: US 2008/0054845 A1
(43) Pub. Date: Mar. 6, 2008

(54) Battery charger with electroluminescent panel

(75) Inventor: Jeen-Shuh Wang, Si-jhih City (TW)

Correspondence Address: TROXELL LAW OFFICE PLLC, SUITE 1404, 5205 LEESBURG PIKE, FALLS CHURCH, VA, 22041, US

(73) Assignee: JASON AUTO TECHNOLOGY CO., LTD.

(21) Appl. No.: 11/783,901

(22) Filed: Apr. 12, 2007

(30) Foreign Application Priority Data
Apr. 17, 2006 (TW) 095206439

(51) Int. Cl. H02J 7/00

(52) U.S. Cl. 320/111

(57) ABSTRACT

A battery charger with electroluminescent panel primary comprises a battery charger, an electroluminescent panel and a housing. The electroluminescent panel is connected to a battery charger and having a driving controller and cables of driver circuit, the battery charger having a charger controller and cables of charger circuit, and the housing accommodating the battery charger and electroluminescent panel. The electroluminescent panel is attached to the battery charger by means of the connecting cables to be displayed the information of charging. The electroluminescent panel is installed at easy-to-reach display location for the convenience of its users. Other features beneficial to users include a better display interface of charged progress, charging capacity display, alarm information, company logo, as well as, indicating the battery capacity instead of voltage instrument when the city power source does not connect with the battery charger.

### BACKGROUND OF THE INVENTION

This invention relates in general to battery chargers and more particularly to a battery charger that has luminescent panel to display the power, progress of charging, alarm information, logo, battery level and capacity measures.

New and variables electrical devices had exploded in recent year. The use of re-chargeable batteries and battery chargers, becomes quite popular in electric vehicles, electric toys, home electrics, monitoring and safety systems, vehicle electrics, and mobile telephones. Even that, batteries are classified to lead-acid battery, Ni—Cd battery, Ni—H battery and Li-ion/polymer battery, etc., the chargers are same. In general, the users' basic requirements for battery charger are full of charge and safety charge. Thus, the display function to the status of charging is paid much attention to users.

Usually, to display the charging process, progress, safety alert information, etc., are typically designed in one of following ways: (1) no any display; (2) used LEDs to display the power and fail sign; (3) used single color or colors LEDs to display the sign of power, fail, charging progress, full of charge, or even the level of battery (usually display by %) etc., the FIG. 5 illustrates the LED display battery charger 21 with LED lights 22; (4) used single color or colors LCD to display the charging information, the FIG. 6 illustrates the LCD display battery charger 23 with LCD panel 24; (5) used the opening degree of funny animal eyes or cute doll's eyes to display the level of charging for delight purpose.

However, the prior art uses single or plurality LEDs in display the charging progress and the level of battery is less pleasing and less humanity; uses single color LCD is insufficient brightness and monotonous; uses colors LCD is bringing the complexity of circuit and raising the cost; or, uses the opening degree of eyes can show the level of battery only, not easy to display other essential information.

In the past, electroluminescent (hereinafter simply referred to as EL) have been known as in harsh and demanding industrial display environments. Compact and lightweight, they are totally solid-state structures with superb shock and vibration resistance. Because the shorter wave length of EL, tinge in brightness, high brightness and contrast, wide viewing angle >160°, rapid display response <10 μs, low EMI emissions, reliable, and, long operating life, EL becomes a good media in display usages.

More reasons for EL panel in electrics display are: 1) thin and easy cut to form any shapes; 2) easily plane the colorful pictures, logo, characters, layouts by silk print; 3) wide temperature range −20° C.˜90° C.; 4) humility resistance 95% RH; 5) low power consumption 0.02˜1.0 mA/cm². Thus, EL panel is a suitable media for the innovation in electrics, illumination, and advertisement application. For examples, U.S. Pat. No. 6,558,018 invents in vehicle light; U.S. Pat. No. 6,866,678 invents in phototherapy device; U.S. Pat. No. 6,644,826 invents in light apparatus for article web; TW patent M280620 invents in electric panel; TW patent M280620 invents in cosmetic device; TW patent M255376 invents in illuminate apparatus; TW patent 00580160 invents in computer board panel. More applications prove that the EL can realize in electrics for pleasing to user eyes.

Considering the battery charger in use by popular, users demand a fashion outlook and can measure the battery capacity conveniently. More demands are request to friendly (or funnily) display the charging process, progress, full of charging, and, abnormal information for safety. U.S. Pat. No. 5,274,321, TW 00580218, TW M249223, TW M246887, CN200310117142.8, CN022165885.1 invent the charger display by using the opening degree of funny animal eyes or cute doll's eyes to display the level of battery (to display the battery capacity) for delight purpose, or, using the mono-color LED, colors LED, even LCD to show the charging progress and other information.

However, the trend of newly smart charger can estimate the condition of battery then ignite an optimum charging tactic automatically, example as, the inventor's US20060145658“Method and device for battery charger and diagnosis with detectable battery energy barrier” needs an intelligent and friendly media to display the charging information.

Therefore, to disclose a convenience, user friendly, more pleasing, more humanity, more artist, convenient, and picturized interface to display the capacity of battery, charging process, progress, full of charging, alarm information, as well as, being a convenient gauge to measure the capacity of battery without the city power; improves the battery charger in useful.

### SUMMARY OF THE INVENTION

The primary objective of the present invention is to provide a battery charger with electroluminescent panel that causes display information in luminous signals on the battery charger, being a convenient and picturized display panel.

The secondary objective of the present invention is to provide a battery charger with electroluminescent panel with integration the electric circuit of charger and electroluminescent driver to give out a user friendly display in charging process, progress, alarm information and indicated the capacity of battery.

The further objective of the present invention is to provide a battery charger with electroluminescent panel that can be a convenient gauge measuring the capacity of battery without connection the charging power.

The another objective of the present invention is to provide a battery charger with electroluminescent panel that layouts the colorful pictures, commercial logo, charging process diagram, trade mark, alert information showing in variable display sections and variable time sequence.

To this end, there is provided a battery charger with electroluminescent panel comprising, a battery charger, an electroluminescent panel and a housing.

The features and structure of the present invention will be more clearly understood when taken in conjunction with the accompanying figures.

### BRIEF DESCRIPTION OF THE DRAWINGS

The features of the present invention, which are believed to be novel, are set forth with particularity in the appended claims. The present invention, together with further objects and advantages thereof, may best be understood by reference to the following description, taken in conjunction with the accompanying drawings, in the several figures of which like reference numerals identify like elements, and in which:

FIG. 1 illustrates perspective views of a battery charger in accordance with embodiment 1 of the inventive arrangements, said screen type;

FIG. 2 illustrates a schematic view of FIG. 1;

FIG. 3 illustrates a front view of an adjustable battery charger in accordance with embodiment 2 of the inventive arrangements, said lid type;

FIG. 4 illustrates side views of an adjustable battery charger in accordance with embodiment 3 of the inventive arrangements, said insert type;

FIG. 5 illustrates the prior art battery charger with LED display; and;

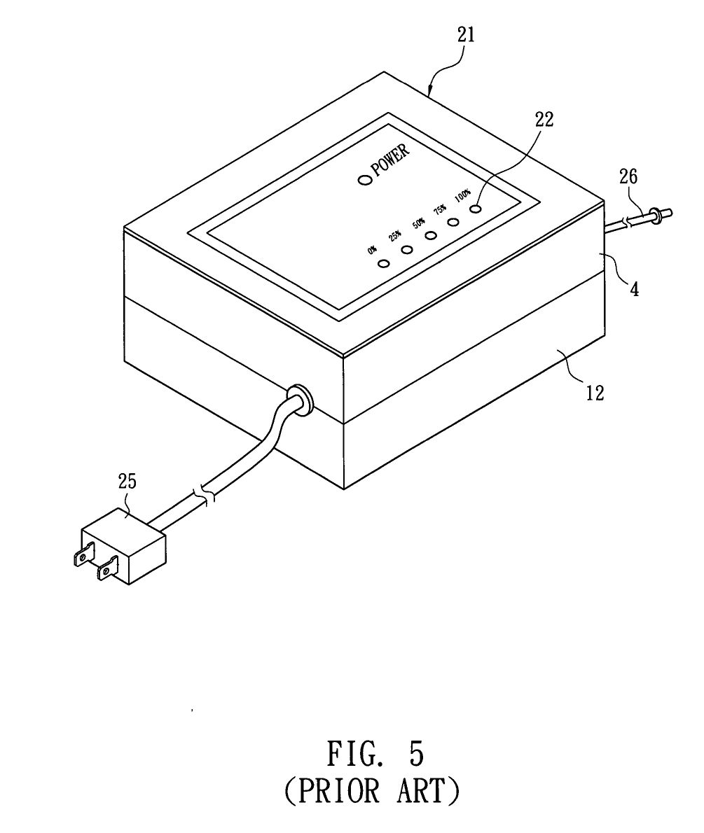

FIG. 6 illustrates the prior art battery charger with LCD display;

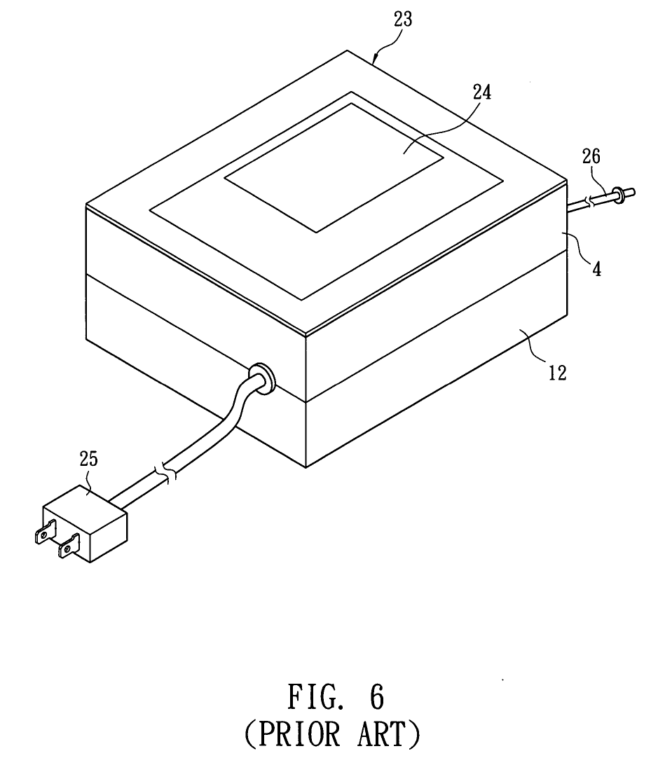

### DETAILED DESCRIPTION OF THE PREFERRED EMBODIMENT

While the specification concludes with claims defining the features of the present invention that are regarded as novel, it is believed that the present invention will be better understood from a consideration of the following description in conjunction with the drawing figures, in which like reference numerals are carried forward.

As required, detailed embodiments of the invention are disclosed herein; however, it is to be understood that the disclosed embodiments are merely exemplary of the present invention, which can be embodied in various forms. Therefore, specific structural and functional details disclosed herein are not to be interpreted as limiting, but merely as a basis for the claims and as a representative basis for teaching one skilled in the art to variously employ the invention in virtually any appropriately detailed structure. Further, the terms and phrases used herein are not intended to be limiting but rather to provide an understandable description of the invention.

The terms “a” or “an”, as used herein, are defined as one or more than one. The term “plurality”, as used herein, is defined as two or more than two. The term “another,” as used herein, is defined as at least a second or more. The terms “having,” as used herein, are defined as comprising (i.e., open language). The terms “cable”, as used herein, is defined as connected the powers or signals, although not necessary wire, and not necessary built in PCB. The terms “charging power”, as used herein, is defined as power supplied to charger, examples as city electric, power supplied by generator, and, power supplied by voltage converter, etc.

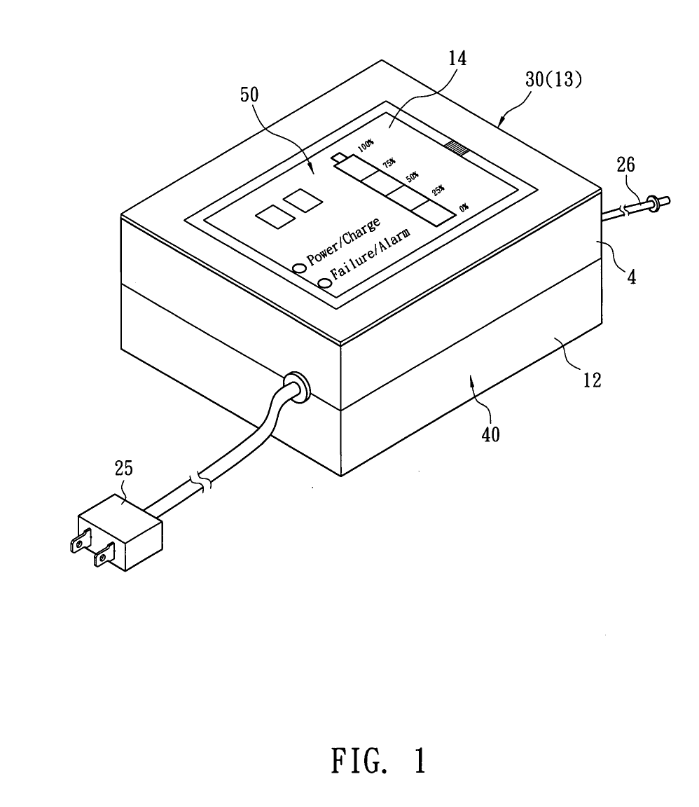

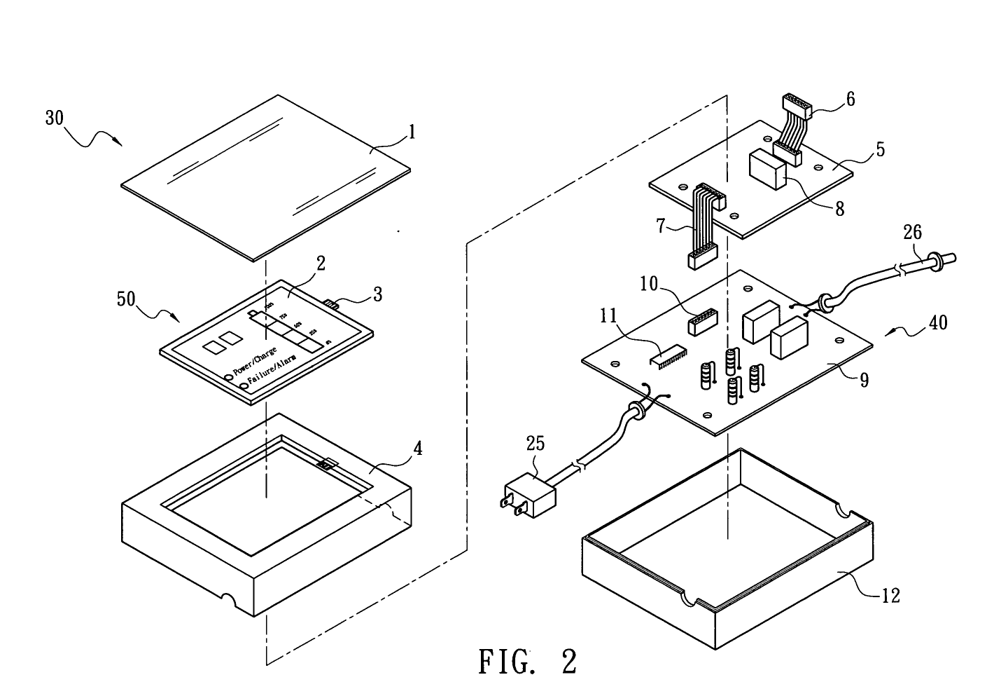

According to the present invention, the structure of the a battery charger with electroluminescent panel, as implemented in one embodiment shown in FIGS. 1 to 2, said embodiment 1, showing a screen type battery charger 13, comprising a battery charger 40, an electroluminescent panel 50 and a housing (assembled by the first part of charger housing 4 and the second part of charger housing 12), wherein, the charging power, said the city electric power is connected to power input cord 25, said the power input cord 25 transmits the electric power battery charger 40. Usually, the electric power is city electric with 110 VAC or 220 VAC, sometimes, power from a generator or power converter. The battery charger 40 sends out the charge output to battery through the charge output cord 26. Wherein, the charging power is transmitted into the battery charger 40, the battery charger 40 senses the battery status, said the capacity of battery, which the capacity of battery may be sensed by voltage or capacity (example %, or amp-hour), then takes an optimum charging tactic to send out the charge output through charge output cord 26, said the charge output is appropriate to the present status of battery. In general, the charging tactic is switching with the progress of charging, which includes pulse impulse, constant current mode (CC mode), constant voltage mode (CV mode) and floating charging etc. More that, in some cases, the battery charger 40 has the function that can detect the battery internal resistance to diagnosis the abnormal battery, or even, diagnoses the abnormal charging among charging power, charging process, charging progress, battery charger itself and the battery. The battery charger 40 integrates the sensed status then sends out the display information.

The display information may be resulted from battery charger 40, being display electrical signal, said EL driving signal, sent to the electroluminescent panel 50 to display. Wherein the display information maybe included one or plurality of, the charging power, the charging voltage, the charging current, the battery capacity, the charging process, the charging progress, the alarm, the alert, the abnormal charging, logo and trademark etc.

The electroluminescent panel 50 inside a screen type EL panel 14 (same as, EL picture panel 2 (in FIG. 2)), can transmit the display electrical signals, said EL driving signals, and drive the screen type EL panel 14 to display the display information with variable display sections and variable time sequences.

The power input cord 25 and charge output cord 26 are fastened on the housing and the electroluminescent panel 50 mounted on. In which, the housing is assembled by the first part of charging housing 4 and the second part of charging housing,

In FIG. 2, to illustrate the detail structure of this screen type battery charger 13. The battery charger 40 is comprising, charging PCB 9, charging controller 11, power input cord 25, charge output cord 26, and, other necessary electrical elements (not shown in figures). The charging PCB 9 converts the charging power into charge output by the control of charging controller 11 and sends the display signals through cable connector 10, wherein the charging controller 11 may calculate the voltage/current from the loop, and comparison with the inside program, take the suitable charging action, control the output voltage/current, diagnose the abnormal, and, send the display signals according to the display information. The program inside of charging controller 11 may integrate the charging tactic, diagnosis method, alert conditions, and the needed information to be displayed, etc.

The electroluminescent panel 50 is comprising, the EL driver PCB 5, driver controller 8, charging controller cable 7, driver cable 6, EL picture panel 2 (screen type EL panel 14 in this example), and, EL panel connector 3. The charging controller cable 7 is connected with cable connector 10 after assembly. The display signal is sent through cable connector 10 to the charging controller cable 7, and sends to the EL driver PCB 5, and converted by driver controller 8, then the driver controller 8 output a series driving signals with the co-operation of the EL driver PCB 5 to control the EL picture panel 2 being variable display sections and variable time sequences through the connection with driver cable 6. Usually, the EL picture panel 2 is layout by some display sections, each display section having pictures and characters. The driving signals from the EL driver PCB 5 can drive the different display section by bright, dark, flash and time to flaunt the pictures and characters. The user may be noticed the display information to understand and to operate the battery charger.

To prevent the pierced, water and dust proof, a cover film 1 may be covered on the EL picture panel 2.

The display information may be included the measurement results to battery. In the process of charging, the driver controller 8 and charging PCB 9 can sample the voltage/internal resistance, convert into capacity of battery, abnormal of battery, etc., and send out the display information. Furthermore, being a convenient capacity gauge, this invention, battery charger with electroluminescent panel, can measure the capacity of battery, abnormal of battery and display them, by connection the charge output cord 26 with the battery only, without connection to the charging power (e.g., city electric). When the battery charger with electroluminescent panel is connected to the battery, the battery charger 40 has the electrical power from the battery, so called working voltage. The charging PCB 9 and charging controller 11 are ignited by the working voltage. Then charging PCB 9 and charging controller 11 senses the battery voltage/internal resistance by send out a pulse and ignites program to calculate. The charging controller 11 is co-operated with charging PCB 9 and send out the display signals. Result that, the EL picture panel 2 displays the battery capacity, battery abnormal. Since that, the power consumption of electroluminescent panel is 0.02˜1.0 mA/cm², much lower than LED driving circuit and LC D driving circuit. Thus, this invention can be working to display by EL in avoiding the voltage drop of battery.

This is one of the features, user can use the apparatus being a convenient gauge instead of instruments. This way can easily display the battery level (or, battery capacity) and identity an abnormal battery, without supplying by charging power.

Different designs of this embodiment, may integrate the EL driver PCB 5 with charging PCB 9 in one, this meaning, used a same PCB to integrate electrical elements of EL driver PCB 5 and charging PCB 9; or, integrate driver controller 8 with charging controller 11 in one, this meaning, used a same controller IC to integrate driver controller 8 and charging controller 11; for purposes.

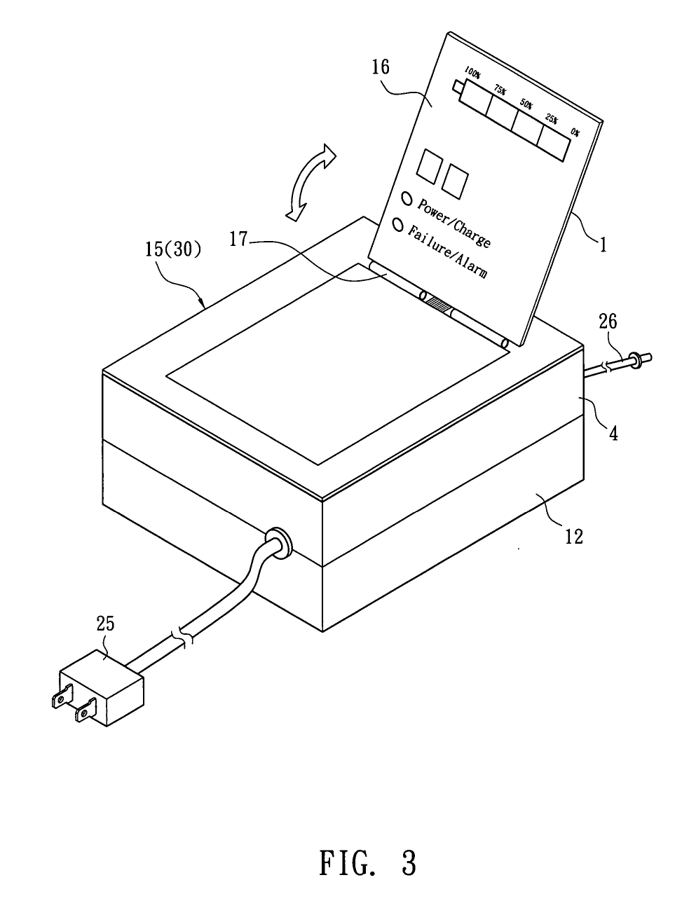

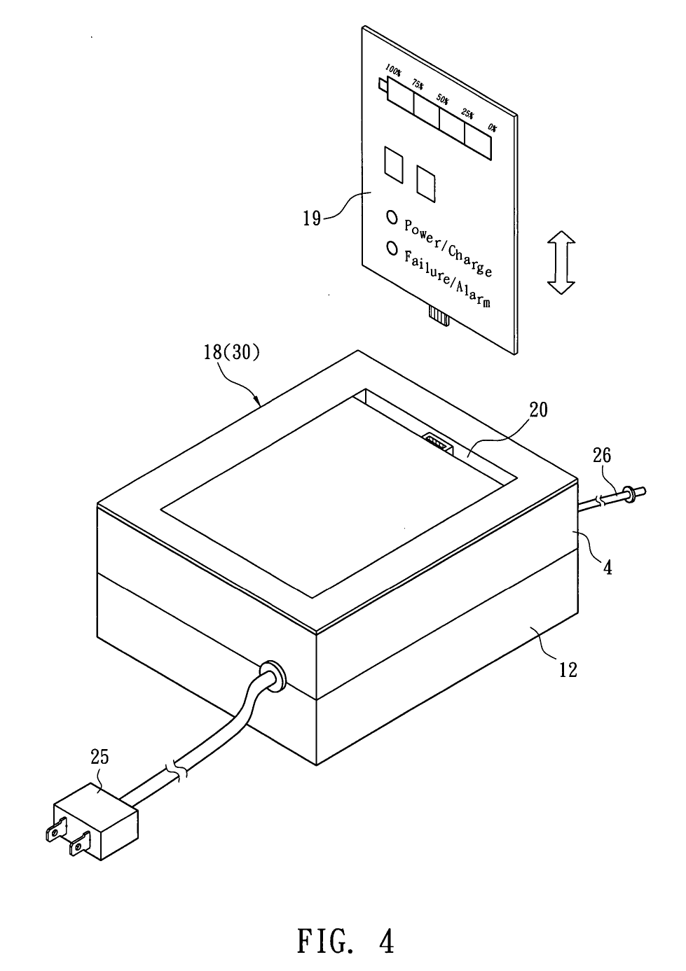

As descriptions of previous, the designer can realize this invention with more features are, at least:
(a). Since the low power consumption of electroluminescent, according to the teaching of this invention, designer can tune the power consumption to EL driver PCB 5 and EL picture panel 2 without increasing the extra power and electrical elements, that restrains the cost.
(b). Since the charging controller 11 recognized, diagnosed and decided a lot of valuable information, the EL picture panel 2 can display them without waste.
(c). Since the friendly of electroluminescent, designer can layout the picture sand characters to flaunt the display information, the charging power, the charging voltage, the charging current, the battery capacity (included full of charge, abnormal battery), the charging process, the charging progress, the alarm, the alert, abnormal charging, and logo, etc. by using different colors, pictures and characters in change the bright, darkness, flash, sequence, time, brings an artistic and humanize charger to users.

In which, the assembly manner of EL panel picture panel 2 with housing is not limited, it may be different types, for examples,
(1). As shown in FIGS. 1 and 2, so called screen type battery charger 13, wherein, the screen type EL panel 14 is fastened on the first part of charger housing 4, used the screw (agglutination, UV are other examples) to fastened. Sometime, sealed a cover film 1 to prevent the dust and humility.
(2). As shown in FIG. 3, said embodiment 2, so called lid type battery charger 15, wherein, the lid type EL panel 16 is covered a cover film 1 first, then the driver cable 6 is through into an opening of the first part of charger housing 4, and connected with EL panel connector 3. The lid type EL panel 16 is bolted on the shaft 17 of the first part of charger housing 4. Thus, the lid type EL panel 16 can be folded to any angle by user pleased to easy read.
(3). As shown in FIG. 4, said embodiment 3, so called insert type battery charger 18, wherein, insert type EL panel 19 is covered a cover film 1 first, the first part of charger housing having a slot 20, then the insert type EL panel 19 is slotted into the slot 20. At mean time, the insert type EL panel 19 is fixed into the slot 20 and connected EL panel connector 3 with driver cable 6 to operation.

Also, users can prepare different models of insert type EL panel 19, which layout different picture, logo and characters on. Thus, user can select a different model for different purpose and delight being an advertisement, or light in darkness, etc.

The present invention has been described using exemplary preferred embodiments. However, it is to be understood that the scope of the present invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A battery charger with electroluminescent panel for charging a battery and showing the display information, comprising: a battery charger, an electroluminescent panel and a housing; wherein:
said battery charger having a power input cord for transmitting charging power into charging PCB; a charging PCB having a charging controller for providing charging output, converting the display information into display signals, and, transmitting the display signals to electroluminescent panel; and a charge output cord for transmitting the said charge output to the battery;
said electroluminescent panel having a driver controller receiving the display signals from charging PCB and providing the EL driving signal to EL driver PCB; an EL driver PCB receiving the EL driving signal and driving the EL picture panel in display; and an EL picture panel, which receiving the EL driving signal from EL driver PCB to showing out the said display information; and
said housing having a first part of charging housing and a second part of charging housing for accommodating the battery charger and electroluminescent panel;
Wherein, said the display information for in display comprising one or plurality other charging power, the charging voltage, the charging current, the battery capacity, the battery abnormal, the charging process, the charging progress, the alarm, the alert, abnormal charging, and logo.

2. The battery charger with electroluminescent panel according to claim 1, wherein the EL picture panel pre-layout a or plurality of display section, wherein, the display section is printed the sign of display information, and receiving the EL driving signal for showing the display information in variable sections and variable time sequences.

3. The battery charger with electroluminescent panel according to claim 2, wherein the sign of display information of each display section on EL picture panel may be printed picture sign or character sign or both of picture and character sign.

4. The battery charger with electroluminescent panel according to claim 1, wherein the display information of the battery capacity or the battery abnormal furthermore comprising the un-charging step, wherein, the display information of un-charging step battery capacity or battery abnormal can be displayed when the battery charger is not in charging to battery, moreover, without connection power input cord with charging power.

5. The battery charger with electroluminescent panel according to claim 1, wherein the EL picture panel is mounted and fixed on the housing.

6. The battery charger with electroluminescent panel according to claim 1, wherein the EL picture panel is bolted on the housing and may be folded to desired angle.

7. The battery charger with electroluminescent panel according to claim 1, wherein the EL picture panel is moveably slotted into the housing and may be changeable.

8. The battery charger with electroluminescent panel according to claim 7, wherein the EL picture panel can be one or plurality, which the EL picture panel may be designed in one or plurality of different display sections in different sign of display information for user delight in selection.

9. The battery charger with electroluminescent panel according to claim 1, wherein the EL driver PCB may be integrated with the charging PCB in one.

10. The battery charger with electroluminescent panel according to claim 1, wherein the driver controller may be integrated with the charging controller in one.
